(19) United States
(12) Patent Application Publication
(10) Pub. No.: US 2004/0126103 A1
(43) Pub. Date: Jul. 1, 2004

(54) Method and apparatus for data access in a video recorder with a disk drive

(75) Inventor: Katsuki Uwatoko, Tachikawa-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/737,880

(22) Filed: Dec. 18, 2003

(30) Foreign Application Priority Data
Dec. 26, 2002 (JP) 2002-378270

(51) Int. Cl. H04N 5/781

(52) U.S. Cl. 386/125; 386/126

(57) ABSTRACT

In a disk storage apparatus for accessing a disk drive according to a data access request accompanied by recording or reproduction from plural applications, a disk driver secures a buffer area for guaranteeing a predetermined throughput in a memory according to a data access request accompanied by recording or reproduction from the plural applications. The disk driver issues a command corresponding to each data access request to the disk drive so as to control read/write access of stream data.

### CROSS-REFERENCE TO RELATED APPLICATIONS

This application is based upon and claims the benefit of priority from the prior Japanese Patent Application No. 2002-378270, filed Dec. 26, 2002, the entire contents of which are incorporated herein by reference.

### BACKGROUND OF THE INVENTION

1. Field of the Invention

The present invention generally relates to the field of a digital recording/reproducing apparatus and more particularly to a video recorder which uses a disk drive as its recording medium.

2. Description of the Related Art

In recent years, for example, a video recorder which uses a hard disk drive (hereinafter referred to as a disk drive) as its recording medium has been developed. Such a video recorder is usually called an HDD video recorder for recording and reproducing broadcast programs and is a kind of personal video recorder.

The performance of data access to the disk drive is important for the video recorder to record or reproduce stream data such as a video picture received through a TV tuner. More specifically, because an application program for recording or reproducing stream data needs continuous data access, it guarantees throughput (usually, data transfer speed) of the data access.

Recently, multiple stream data can be accessed at the same time by a single physical disk (recording medium). That is, this is a data access for multiple application programs to simultaneously record or reproduce broadcast programs in different channels (see Jpn. Pat. Appln. KOKAI Publication No. 10-333984).

For a single stream data access, the throughput of the data access can be guaranteed. However, for access of plural stream data, the throughput of those data accesses is difficult to guarantee. To guarantee the throughput of the data accesses, appropriate scheduling for managing the buffer area for storing data when the disk drive is accessed, in accordance with a request from the application program, is needed.

### BRIEF SUMMARY OF THE INVENTION

In accordance with one embodiment of the present invention, there is provided a disk storage apparatus for a video recorder including facilities for buffer management.

This storage apparatus comprises a disk drive unit which reads/writes data from/to a disk medium, a memory unit having a buffer area for storing data to be read from or written to the disk medium when the disk drive unit accesses the disk medium, and a controller unit for, when plural data access requests occur to the disk drive unit, securing a buffer area for each of the plural data access requests according to a predetermined condition.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a configuration of a video recorder according to an embodiment of the present invention;

FIG. 2 is a block diagram showing a software configuration of the video recorder;

FIG. 3 is a flow chart for explaining recording/reproduction operation according to the embodiment;

FIG. 4 is a diagram for explaining the condition under a buffer management function according to the embodiment;

FIG. 5 is a flow chart for explaining a processing procedure corresponding to multiple data access requests according to the embodiment; and

FIG. 6 is a flow chart according to another embodiment.

### DETAILED DESCRIPTION OF THE INVENTION

Hereinafter, embodiments of the present invention will be described with reference to the accompanying drawings.

(Configuration of Recording/Reproducing Apparatus)

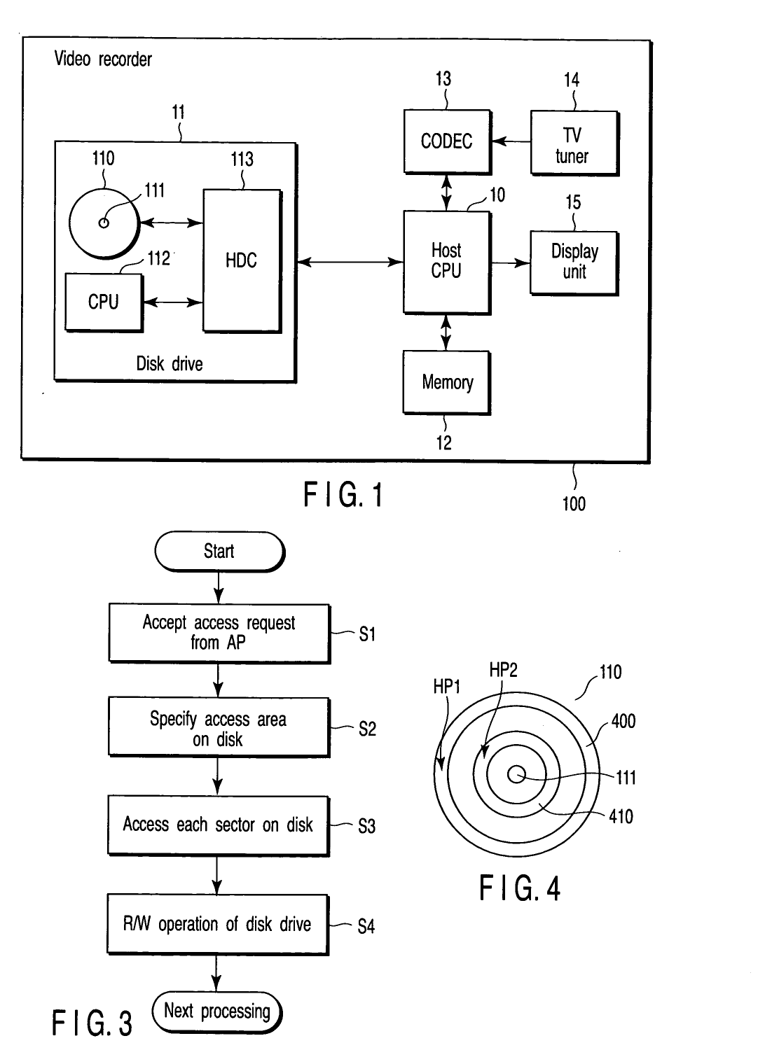

FIG. 1 is a block diagram of a video recorder 100 assumed as a recording/reproducing apparatus according to this embodiment. Meanwhile, the recording/reproducing apparatus of this embodiment may be built into, for example, a digital TV set, not an independent video recorder 100.

The video recorder 100 comprises mainly a host computer (host CPU) 10 which is a main control unit, a disk drive 11, a TV tuner 14 for receiving a broadcast program and a display unit 15.

The disk drive 11 is a hard disk drive which utilizes a disk 110 which is a magnetic recording medium. The disk 110 is rotated by a spindle motor 111. The disk drive 11 records stream data in a broadcast program under the control of the host CPU 10 into the disk 110 and reproduces stream data from the disk 110.

The disk drive 11 contains a microprocessor (CPU) 112 for controlling a read/write mechanism to the disk 110 and a disk controller (HDC) 113 which constitutes an interface with the host 10.

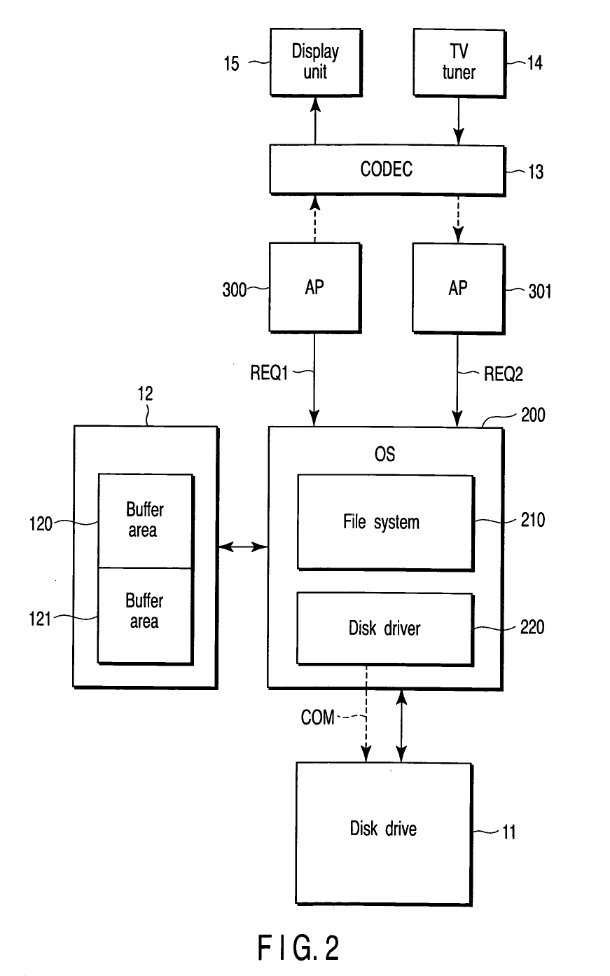

The host CPU 10 executes an application program (referred to as AP or sometimes called just application) which executes recording/reproducing operation of the stream data under the control of an operating system (OS) (see FIG. 2).

The host CPU 10 has a management function for managing a buffer area necessary for the recording/reproducing operation of the stream data. Usually, a memory 12 is a main memory for the host CPU 10, and constituted of a dynamic RAM (DRAM). The memory 12 is used for securing a buffer area necessary for application's data access under the control of the OS (more specifically, disk driver).

The TV tuner 14 selects a specified broadcast program from TV broadcasting such as digital broadcasting and outputs corresponding stream data to a CODEC 13. The CODEC 13 is hardware for compressing or decompressing stream data under a specified standard. The CODEC 13 may be a processing section which is realized by software. The display unit 15 has a display which displays various kinds of information relating to the recording/reproducing operation under the control of the host CPU 10.

The video recorder 100 has an output unit for outputting stream data reproduced under the control of the host CPU 10 to, for example, a TV set. This output unit enables a reproduced video picture displayed on a screen of the TV set.

(System Configuration)

FIG. 2 is a block diagram showing a configuration of software in mainly the host CPU 10.

As shown in FIG. 2, an OS 200 including a file system 210 and a disk driver 220 is incorporated in the host CPU 10. The OS 200 accesses the disk drive 11 according to data access requests (REQ1, REQ2) accompanied by the recording/reproducing operation from multiple applications (AP) 300, 301.

More specifically, the file system 210 determines a place (address) on the disk 110 of the disk drive 11 whose access (read request or write request) is requested by the applications 300, 301. The disk driver 220 issues a command (COM) for accessing the disk drive 11 according to an access request and address transferred by the file system 210. That is, the disk driver 220 is software (a kind of device driver) for controlling input/output of read/write data (stream data) to/from the disk drive 11.

If, for example, the access request (REQ1) from the application 300 is a read request, the disk driver 220 transfers a read command containing an address on the disk 110 to the disk drive 11. On the other hand, if the access request (REQ2) from the application 301 is a write request, the disk driver 220 transfers a write command containing an address on the disk 110 to the disk drive 11.

Further, the disk driver 220 controls the buffer area in the memory 12 necessary for data access as described later. More specifically, the disk driver 220 executes buffer management processing for securing a buffer area (that is, data amount to be transferred) necessary for pre-reading operation and post-write operation of the stream data in the memory 12 in order to make continuous access upon the stream data.

(Data Access Operation Accompanied by Recording/Reproducing Operation)

The recording/reproducing operation of this embodiment will be described with reference to FIGS. 3 to 5 as well as FIGS. 1 and 2.

First, the procedure for data access operation accompanied by the recording/reproducing operation of the video recorder 100 will be described with reference to the flow chart of FIG. 3 and FIG. 4.

According to this embodiment, as shown in FIG. 4, a first recording area 400 and a second recording area 410 are assumed on the disk 110 for convenience. The first recording area 400 includes multiple tracks relatively on an outer periphery, serving for a recording area for the access request of the first application 300.

On the other hand, the second recording area 410 includes multiple tracks relatively on an inner periphery, serving as a recording area for the access request of the second application 301. In the meantime, signs HP1, HP2 mean the positions of a head for reading/writing data from/to the disk 110.

The OS 200 receives the data access requests REQ1, REQ2 relating to the recording/reproducing operation from the applications 300, 301 (step S1). Assume that the read access request REQ1 for reading stream data recorded on the disk 110 is made from the first application 300 for the reproduction operation. On the other hand, assume that a write access request for writing stream data received by the TV tuner 14 to the disk 110 is made from the second application 301 for the recording operation.

After receiving the access requests (REQ1, REQ2), the file system 210 specifies recording areas (400, 410) which are access objects on the disk 110 (step S2). More specifically, the file system 210 sets up an address on the disk 110 which is a read/write object of the stream data.

The disk driver 220 issues a command (COM) to the disk drive 11 in accordance with the access requests (REQ1, REQ2) transferred from the file system 210 and each address (step S3). The command instructs to access (read/write) data of each sector from the disk 110.

That is, the disk driver 220 transfers a read command to the HDC 113 of the disk drive 11 according to the data access request REQ1 from the first application 300. The read command includes addresses (track address and sector address) contained in the first recording area 400 on the disk 110. A write command is transferred to the HDC 113 of the disk drive 11 according to the data access request REQ2 from the second application 301. The write command includes addresses (track address and sector address) contained in the second recording area 401 on the disk 110.

In the disk drive 11, its CPU 12 controls the read/write mechanism following a command (COM) received through the HDC 113 and executes the data read/write operation from/to the disk 110 (step S4).

That is, following the data access request REQ1 from the first application 300, the CPU 112 positions the head included in the read/write mechanism at a position HP1 contained in the first recording area 400 as shown in FIG. 4. The head reads stream data from multiple sectors contained in the corresponding position HP1. On the other hand, following the data access request REQ2 from the second application 301, the CPU 112 positions the head included in the read/write mechanism at a position HP2 contained in the second recording area 410 as shown in FIG. 4. The head writes stream data to multiple sectors contained in the position HP2.

(Management on Buffer Area)

As described above, the host CPU 10 executes read/write control of the disk drive 11 according to data access requests from the plural applications 300, 301 under the control of the OS 200. The host CPU 10 transfers stream data corresponding to the data access request to the disk drive 11. At this time, the disk driver 220 executes pre-read operation or post-write operation from or to the disk 110 in order to achieve transfer of the stream data under a predetermined condition.

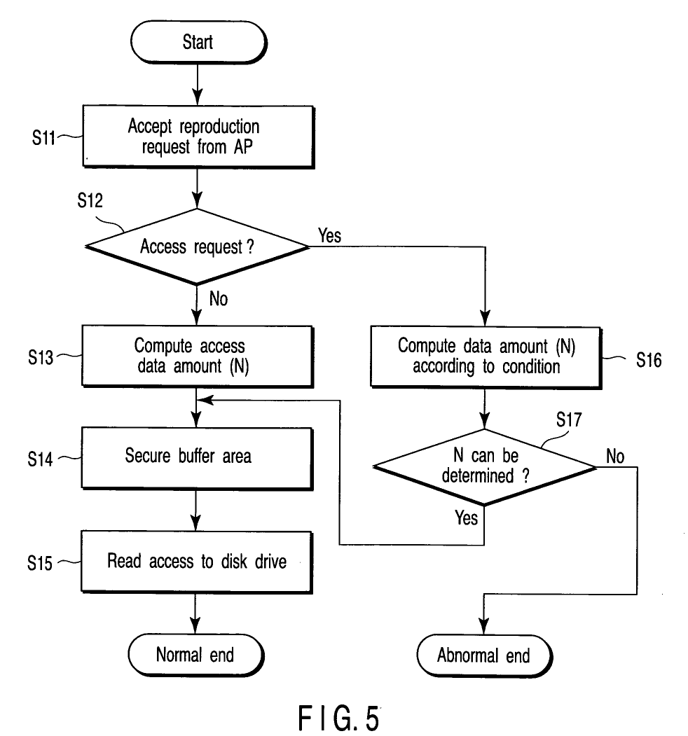

Next, the buffer area management operation for the memory 12 to be executed by the disk driver 220 upon the pre-read operation or post-write operation will be described with reference to FIG. 2 and the flow chart of FIG. 5.

The performance of the disk drive 11 and the specification requested by the applications 300, 301 upon data access include the following items.

That is, the performance of the disk drive 11 includes head traveling speed (Hs: for example, traveling distance of one track per second) and data transfer speed (Ds: megabit/sec). The specification of the applications 300, 301 includes throughput (that is, data transfer speed Ts: megabit/sec) and a maximum delay time (Mt seconds) of a response corresponding to an access request.

Next, an operation which occurs when a data access request accompanied by a stream data reproducing operation is made from the application 300 or 301 will be described with reference to the flow chart of FIG. 5.

If the OS 200 accepts a data access request from the application 300 or 301; the file system 210 and the disk driver 220 execute a sequence of processings as shown in FIG. 3 (step S11). Here, as for the data access request, a case where it is made from only the first application 300, for example, is assumed (NO in step S12).

The disk driver 220 computes a data amount (N: minimum value) for securing a buffer area following the request (step S13). That is, the disk driver 220 computes a data amount (N) according to a conditional expression “N=Dt×Ds, where Dt is data transfer time” on the basis of the data transfer speed (Ds: megabit/sec) obtained from the disk drive 11. The disk driver 220 secures a buffer area corresponding to the computed data amount (N) in the memory 12 (step S14).

Subsequently, the disk driver 220 issues a command following an access request (read command) and executes a read access in the disk drive 11 (step S15). The disk drive 11 transfers stream data read from the disk 110 to the disk driver 220 in response to the read command. The disk driver 220 temporarily stores the transferred stream data in the secured buffer area.

On the other hand, it is assumed that, for example, when an access request is accepted from the second application 310, the access request from the first application 300 has been already accepted (YES in step S12).

In such a case, the disk driver 220 computes a data amount (N) through pre-read operation under a predetermined condition (step S16). The predetermined condition concerns throughput (data transfer speed Ts: megabit/sec) requested by the aforementioned application and maximum delay time (Mt second) of response. More specifically, a conditional expression (1) relating to the maximum delay time (Mt) and a conditional expression (2) relating to throughput (Ts) are assumed:

Mt<(Ht+Dt) (1)

Ts<N/(Ht+Dt) (2)

where Ht is a head traveling time, and Dt is data transfer time as described above. The head traveling time Ht is expressed by the following expression (3):

Ht=|X−Y|×Hs (3)

Where Hs means a head traveling speed as described above. X means a head position (HP1) when the stream data is read from the recording area 400 of the disk 110 according to an access request from the first application 300 as shown in, for example, FIG. 4. Likewise, Y means a head position (HP2) when the stream data is read from the recording area 410 in the disk 110 according to an access request from the second application 301.

Thus, if the access request from the first application 301 is processed when the access request from the first application 300 is being accepted, the head traveling time Ht can be computed from the aforementioned expression (3).

The data transfer time Dt is expressed according to the following expression (4).

Dt=N/Ds (4)

The disk driver 220 computes a data amount (N) which satisfies the aforementioned conditional expression (2). At this time, if the data amount (N) which satisfies the conditional expression (1) cannot be determined to a throughput (data transfer speed Ts) requested by an application, for example, the disk driver 220 is disabled for accessing and then an abnormal end occurs (NO in step S17).

On the other hand, if the data amount (N) which satisfies the aforementioned relational equation (2) can be determined, the disk driver 220 secures a buffer area corresponding to the computed data amount (N) in the memory 12 (YES in step S17, S14).

That is, if there is a data access request from the plural applications 300, 301, the disk driver 220 computes a data amount (N) for securing a buffer area which satisfies throughput (Ts) accompanied by that data access request. The disk driver 220 secures a buffer area corresponding to the data amount (N) and executes access control (issue of command) of the disk drive 11 following the data access request.

According to this embodiment, as shown in FIG. 2, the disk driver 220 secures a buffer area 120 in, for example, the memory 12 corresponding to the data access request from the first application 300. On the other hand, the disk driver 220 secures a buffer area 121 which satisfies the above-described condition corresponding to the data access request from the second application 300. As a result, the disk driver 220 temporarily stores stream data transferred from the disk drive 11 in the buffer area 120 corresponding to the data access request from the first application 300.

Additionally, the disk driver 220 temporarily stores stream data transferred from the disk drive 11 in the buffer area 121 corresponding to the data access request from the second application 300.

Thus, the video recorder 100 outputs stream data reproduced from, for example, the recording area 400 on the disk 110 on the display unit 15, according to the data access request from the first application 300. Further, the stream data can be read in advance from the recording area 410 on the disk 110, for example, according to the data access request from the second application 300 and temporarily stored in the buffer area 121. In other words, the stream data can be read in advance so as to satisfy the throughput condition accompanied by the data access request from the second application 300 in order to achieve a reproducing operation for outputting to the display unit 15.

Meanwhile, this embodiment explains control of the buffer area for plural applications to make the data access request for their reproducing operation. This embodiment is not restricted to this example, but may be applied to a case where the first application 300 executes a read access request accompanied by the reproducing operation while the second application makes a write access request accompanied by the recording operation. In this case, the disk driver 220 secures the buffer area 121 necessary for post-write of the stream data in the recording area 410 on the disk 110 following the data access request from the second application 301.

(Another Embodiment)

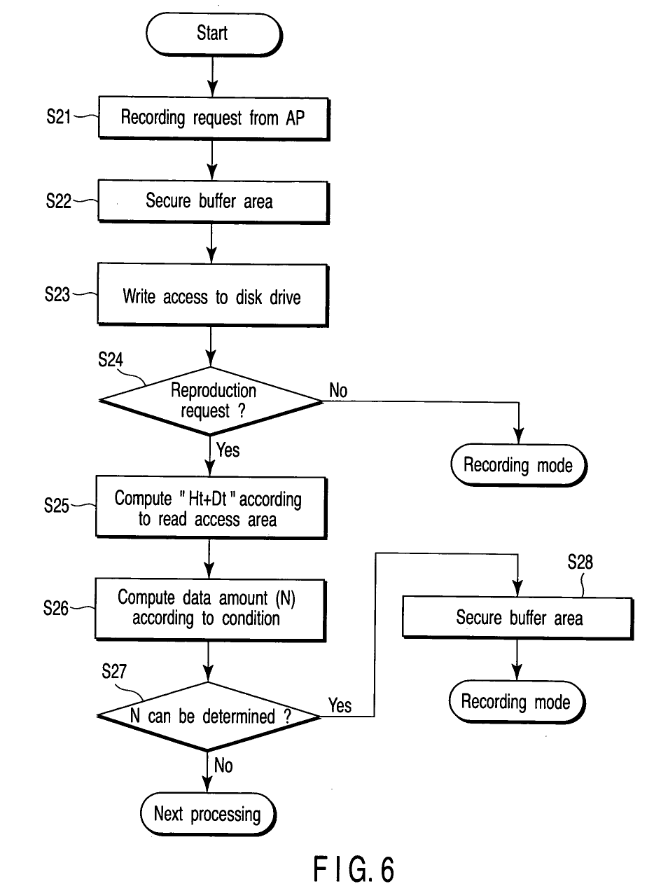

FIG. 6 is a flow chart according to another embodiment.

This embodiment assumes a recording/reproducing operation such as time-shift, in which a reproduction request occurs during recording operation. Hereinafter, this embodiment will be described in detail with reference to a flow chart of FIG. 6.

For example, if a data access request accompanied by the recording operation is accepted from the first application 300, the OS 200 makes the file system 210 and the disk driver 220 execute a series of processings (step S21). That is, the disk driver 220 secures a buffer area following a write access request (step S22).

Next, the disk driver 220 issues a command (write command) following the access request and executes the write access to the disk drive 11 (step S23). The disk driver 11 receives stream data which should be recorded corresponding to the write command and writes to, for example, the recording area 400 on the disk 110.

Here, if the recording operation is suspended, and a reproduction request from the first application 300 is not made, the OS 200 continues data access in a recording mode (NO in step S24).

On the other hand, if the recording operation is suspended, and a reproduction request from the first application 300 is made, the disk driver 220 computes the data amount (N) according to a predetermined condition (step S26). In this case, the disk driver 220 computes the expression “HT+Dt” on the basis of the read access area on the disk 110 (assumed to be the recording area 410 shown in FIG. 4 herein) (step S25).

That is, the head traveling time Ht is computed by the above expression (3). In this case, X means a head position (HP1) when stream data is written to the recording area 400 on the disk 110 according to a write access request from the first application 300. Likewise, Y means a head position (HP2) when stream data is read from the recording area 410 on the disk 110 according to a read access request from the first application 300. Dt means data transfer time as described above.

The disk driver 220 computes a data amount (N) which satisfies the above conditional expression (2). At this time, if the data amount (N) which satisfies the conditional expression (1) cannot be determined to a throughput (data transfer speed Ts) requested by the first application 300, the disk driver 220 is disabled to access following the reproduction request, and continues write access following, for example, the recording request (No in step S27).

On the other hand, when the data amount (N) which satisfies the above conditional expression (2) can be determined, the disk driver 220 secures a buffer area corresponding the computed data amount (N) in the memory 12 (YES in step S27, S28).

In short, this embodiment enables the write access accompanied by the recording operation to be interrupted by the same application, for example, the first application 300 so as to execute a read access following the reproducing operation. In this case, the disk driver 220 secures a buffer area in the memory 12 to satisfy the throughput accompanied by the data access request (read access request) from the first application 300.

Therefore, the video recorder 100 is capable of executing a recording/reproducing operation such as time-shift for executing the reproducing operation following a data access request from the first application 300, during recording operation for storing stream data in the recording area 400 on the disk 110, for example.

In the meantime, although in this embodiment and another embodiment, an independent video recorder 100 is assumed, these embodiments are not restricted to this example, but can be applied to, for example, a recording/reproducing apparatus incorporated in a digital TV unit.

As described in detail above, according to this embodiment, even if plural data access requests occur to the disk drive, the buffer management can be carried out so as to satisfy such predetermined conditions as access performance of the disk drive and throughput (data transfer speed) of application programs.

Therefore, the present invention can be applied to a recording/reproducing apparatus which accesses stream data in the disk drive to record or reproduce it so as to guarantee specified throughputs upon multiple data accesses.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A disk storage apparatus comprising:
a disk drive unit which reads or writes data from or to a disk medium;
a memory unit to, when the disk drive accesses the disk medium, secure a buffer area for storing data to be read or written from or to the disk medium; and
a controller unit which, when plural data access requests occur to the disk drive unit, secures the buffer area for each of the plural data access requests in accordance with a predetermined condition.

2. The disk storage apparatus according to claim 1, wherein the controller unit computes a data amount based on data access performance of the disk drive unit so as to determine whether or not the data amount satisfies the predetermined condition and if a result of the determination satisfies the predetermined condition, secures a buffer area corresponding to the data amount in the memory unit.

3. The disk storage apparatus according to claim 1, wherein the controller unit assumes a throughput accompanied by the data access request as the predetermined condition and secures the buffer area corresponding to data transfer rate which satisfies the throughput.

4. The disk storage apparatus according to claim 1, wherein the controller unit assumes the traveling time of a head which reads/writes data and data transfer time as the data access performance of the disk drive unit, computes a data amount accompanied by the data access performance which satisfies a throughput accompanied by the data access request and secures the buffer area corresponding to the data amount.

5. The disk storage apparatus according to claim 1, wherein the controller unit assumes an addition result of the traveling time of the head in the disk drive and data transfer time as data access performance of the disk drive unit and if the data transfer speed corresponding to the addition result satisfies a throughput accompanied by the data access request as the predetermined condition, secures the buffer area corresponding to the data transfer speed.

6. The disk storage apparatus according to claim 1, wherein the controller unit includes:
a file system which specifies an access area corresponding to each data access request on the disk medium by receiving the plural data access requests; and
a disk driver which issues a command containing a designation of the access area specified by the file system and executes access control on the disk drive unit in accordance with each of the data access requests, the disk driver executing buffer area management for securing the buffer area according to the predetermined condition.

7. The disk storage apparatus according to claim 1, wherein the plural data access requests are generated accompanied by execution of recording operation or reproducing operation by plural application programs.

8. The disk storage apparatus according to claim 1, wherein the plural data access requests are generated accompanied by an execution of recording operation and reproducing operation by a single application program.

9. A method of executing data access in a recording/reproducing apparatus having a disk drive unit which reads or writes data from or to a disk medium and a memory unit to secure a buffer area for storing data to be read from or written to the disk medium, the method comprising:
accepting plural data access requests for accessing the disk drive unit;
securing the buffer area for each of the plural data access requests according to a predetermined condition; and
executing data access control upon the disk drive unit according to each of the plural data access requests using the buffer area.

10. The method according to claim 9, further comprising:
specifying an access area corresponding to said each data access request on the disk medium; and
upon the data access control, receiving a designation of the access area and executing data access to the disk drive unit according to each of the plural data access requests using the buffer area.

11. The method according to claim 9, wherein the accepting accepts a write access request to the disk drive unit;
the securing of the buffer area secures a buffer area in accordance with the write access request;
the data access control executes data access to the disk drive unit according to the write access request; and
the data access control, if a read access request to the disk drive unit is accepted, interrupts data access according to the write access request and secures a buffer area according to the read access request.
